(19) United States
(12) Patent Application Publication
(10) Pub. No.: US 2015/0133589 A1
(43) Pub. Date: May 14, 2015

(54) PIGMENT DISPERSIONS

(71) Applicant: E I DU PONT DE NEMOURS AND COMPANY, Wilmington, DE (US)

(72) Inventors: Brian C. AUMAN, Avondale, PA (US); Donald Douglas MAY, Chadds Ford, PA (US)

(21) Appl. No.: 14/528,406

(22) Filed: Oct. 30, 2014

Related U.S. Application Data
(60) Provisional application No. 61/902,945, filed on Nov. 12, 2013.

(51) Int. Cl. C09D 17/00; C09D 151/00; C09D 153/00

(52) U.S. Cl. CPC C09D 17/008; C09D 17/002; C09D 153/00; C09D 151/003
USPC 524/92; 524/533; 524/188; 524/114; 524/176; 524/96; 524/87; 524/104; 524/100

(57) ABSTRACT

A pigment dispersion includes a pigment, a dispersing agent, a viscosity reducing compound and solvent. The dispersing agent includes a block acrylic compound or a graft acrylic compound.

### BACKGROUND INFORMATION

1. Field of the Disclosure

This disclosure relates to a pigment dispersion.

2. Description of the Related Art

Various color, opacity and/or other property effects can be achieved in articles by incorporating pigments into liquid coating compositions used during the manufacture of these articles. Typical pigments include both clear pigments, such as inorganic siliceous pigments (silica pigments, for example) and conventional pigments. Conventional pigments include metals, metal oxides, metal hydroxides, metal chromates, metal sulfides, metal sulfates, metal carbonates, carbon black, talc, clay, and organic pigments and dyes.

Pigments for use in liquid coating compositions can be employed in the form of a pigment dispersion, in which primary pigment particles are dispersed in an aqueous or non-aqueous liquid. Unfortunately, the primary particles of pigment tend to stick to each other in the course of manufacture and storage, resulting in aggregates and agglomerates many times the desired particle size. This can affect the mechanical properties of articles made using these pigments, as well as introducing visual defects, such as specks and streaks in the final product. The type and amount of pigment dispersion used is generally limited by the compatibility of the pigment dispersion with the other components of the liquid coating composition, the processing conditions used during the manufacturing process and the desired properties of the articles being made. In the case of fluoropolymer coated films, pigment dispersions are selected to prevent any significant adverse effects on the desirable properties of the fluoropolymer coating, e.g., weatherability, as well as being selected for stability at the elevated processing temperatures that may be used during film formation. Manufacturers can use various techniques, such as surface coating and micronization of pigment particles to make dispersion easier and to minimize the aggregates present in a pigment dispersion used in a liquid coating composition.

Fluoropolymer films are recognized as an important component in photovoltaic (PV) modules due to their excellent strength, weather resistance, UV resistance, and moisture barrier properties. Especially useful in these modules are film composites of fluoropolymer film and polymeric substrate film which act as a backing sheet for the module. Such composites have traditionally been produced from preformed films of fluoropolymer, specifically polyvinyl fluoride (PVF), adhered to polyester substrate film, specifically polyethylene terephthalate. When a fluoropolymer such as PVF is used in a backsheet for the PV module, its properties significantly improve the module life, enabling module warranties of up to 25 years. Fluoropolymer backsheets are frequently employed in the form of a laminate with polyethylene terephthalate (PET) films, typically with the PET sandwiched between two PVF films.

Laminates of preformed fluoropolymer films on polymeric substrates having a bond which will not delaminate after years of outdoor exposure are difficult to make. Prior art systems such as U.S. Pat. No. 3,133,854 to Simms, U.S. Pat. No. 5,139,878 to Kim, et al., and U.S. Pat. No. 6,632,518 to Schmidt, et al. describe primers and adhesives for preformed films that will produce durable laminate structures. However, these processes require the application of at least one adhesive layer, or both a primer and an adhesive layer, prior to the actual lamination step. The lamination step then requires the application of heat and pressure to form the laminate. Therefore, laminates using preformed fluoropolymer films are expensive to manufacture and/or require capital intensive equipment. Because preformed fluoropolymer films must have sufficient thickness to provide strength for handling during manufacture and subsequent processing, the resulting laminates may also incorporate thick layers of fluoropolymer, i.e., thicker than are necessary for an effective protective layer.

Liquid coating compositions can provide thinner fluoropolymer films on polymeric substrates using fewer processing steps. Examples of these systems are described in U.S. Pat. Nos. 7,553,540; 7,981,478; 8,012,542; 8,025,928; 8,048,513; 8,062,744; 8,168,297; and 8,197,933, and U.S. Patent Application Publication Nos. 2011/0086954 and 2012/0116016. Some of these systems include the use of primers on the polymeric substrate to be coated, while other systems disclose fluoropolymer coatings applied directly to unprimed polymeric substrates. In the case of using fluoropolymer coatings applied directly to unprimed polymeric substrates, it can be challenging to achieve sufficient adhesion of the fluoropolymer coating to the polymeric substrate. In particular, incorporating pigments and fillers, UV additives and thermal stabilizers, or other barrier particles into the fluoropolymer coating composition can negatively impact the performance of a backsheet made using a fluoropolymer coating on a polymeric substrate film. In a specific example, different pigment dispersions can reduce the adhesion between a fluoropolymer coating and a polymeric substrate film.

In both pigment dispersions and liquid coating compositions, there is a desire to maximize solids loadings in order to minimize the volume of liquids needed for processing, handling, storage, etc. Increasing solids loadings, however, raises viscosity, which can have significant detrimental effects on the processing of liquid coating compositions, such as increasing processing time, decreasing coating uniformity, increasing defect levels in films formed from the coating, etc. Pigment dispersions and liquid coating compositions which allow for higher solids loadings can greatly improve the productivity of the processes in which they are used.

### SUMMARY

A pigment dispersion includes a pigment, a dispersing agent, a viscosity reducing compound and solvent. The dispersing agent includes a block acrylic compound or a graft acrylic compound.

The foregoing general description and the following detailed description are exemplary and explanatory only and are not restrictive of the invention, as defined in the appended claims.

### DETAILED DESCRIPTION

A pigment dispersion includes a pigment, a dispersing agent, a viscosity reducing compound and solvent. The dispersing agent includes a block acrylic compound or a graft acrylic compound.

In one embodiment, the pigment includes a metal oxide compound. In a specific embodiment, the metal oxide compound includes titanium dioxide.

In another embodiment, the viscosity reducing compound includes a coupling agent, an amine or a mixture thereof. In a specific embodiment, the coupling agent includes a silane, a titanate or a zirconate. In another specific embodiment, the viscosity reducing compound includes an amino silane or an epoxy silane. In a more specific embodiment, the viscosity reducing compound is selected from the group consisting of 3-aminopropyltrimethoxysilane, 3-aminopropyltriethoxysilane, N-(n-butyl)-3-aminopropyltrimethoxysilane, N-(2-aminoethyl)-3-aminopropyltrimethoxysilane, N-2-(vinylbenzylamino)-ethyl-aminopropyltrimethoxysilane), 3-glycidoxypropyltrimethoxysilane, β-(3,4-epoxycyclohexyl)ethyltrimethoxysilane and mixtures thereof. In still another specific embodiment, the titanate is selected from the group consisting of isopropyl tri(dioctyl)phosphato titanate, isopropyl tri(N-ethylenediamino)ethyl titanate, neopentyl(diallyl)oxy-tri(m-amino)phenyl titanate, neopentyl(diallyl)oxy-tri(N-ethylenediamino)ethyl titanate, and mixtures thereof. In yet another specific embodiment, the zirconate is selected from the group consisting of neopentyl(diallyl)oxy-tri(diactyl)pyro-phosphato zirconate, neopentyl(diallyl)oxy-tri(N-ethylenediamino)ethyl zirconate, neopentyl(diallyl)oxy-tri(m-amino)phenyl zirconate and mixtures thereof. In still yet another specific embodiment, the amine includes a primary amine, a secondary amine or a tertiary amine. In a more specific embodiment, the amine includes a dialkyl or trialkyl amine of the general structure N—R1R2R3, where R1 and R2 are a C1-C20 linear, branched or cycloaliphatic hydrocarbon, and R3 is hydrogen or a C1-C20 linear, branched or cycloaliphatic hydrocarbon. In another more specific embodiment, the amine is selected from the group consisting of dibutylamine, 4-diazabicyclo[2.2.2]octane, diazabicyclo[5.4.0]undec-7-ene, morpholine, quinuclidine, pyrrolidine, piperazine, and mixtures thereof.

In still another embodiment, the pigment solids content is in a range of from about 50 to about 85 weight percent. In a more specific embodiment, the pigment solids content is in a range of from about 60 to about 80 weight percent. In a still more specific embodiment, the pigment solids content is in a range of from about 70 to about 75 weight percent.

In yet another embodiment, the solids weight ratio of the pigment to the viscosity reducing compound is in the range of from about 10:1 to about 2000:1. In a more specific embodiment, the solids weight ratio of the pigment to the viscosity reducing compound is in the range of from about 20:1 to about 1000:1. In a still more specific embodiment, the solids weight ratio of the pigment to the viscosity reducing compound is in the range of from about 40:1 to about 500:1.

Many aspects and embodiments have been described above and are merely exemplary and not limiting. After reading this specification, skilled artisans appreciate that other aspects and embodiments are possible without departing from the scope of the invention. Other features and advantages of the invention will be apparent from the following detailed description, and from the claims.

### Pigments

In one embodiment, pigments that can be used include both clear pigments, such as inorganic siliceous pigments (silica pigments, for example) and conventional pigments. Conventional pigments that can be used include metallic oxides such as titanium dioxide, and iron oxide; metal hydroxides; metal flakes, such as aluminum flake; chromates, such as lead chromate; sulfides; sulfates; carbonates; carbon black; silica; talc; clay; phthalocyanine blues and greens, organo reds; organo maroons and other organic pigments and dyes. In one embodiment, the type and amount of pigment is selected to prevent any significant adverse effects on the desirable properties of the fluoropolymer coating, e.g., weatherability, as well as being selected for stability at the elevated processing temperatures that may be used during film formation.

In one embodiment, titanium dioxide (TiO₂) may be used as a pigment. The TiO₂ can comprise rutile, anatase, or a combination thereof, although rutile is generally preferred due to its superior photodurability. In one embodiment, the TiO₂ may have a primary particle size of from about 0.1 to about 1.0 μm, or from about 0.2 to about 0.35 μm. As used herein, the term “primary particle size” is meant to refer to the size of individual particles, as opposed to the size of agglomerates of particle. For example, TiO₂ having a primary particle size of from about 0.1 to about 1.0 μm may form agglomerates that are much larger in size when in a pigment dispersion. In one embodiment, the TiO₂ may be surface treated with silica, alumina or a combination thereof. In one embodiment, the TiO₂ may have an organic treatment such as trimethylolpropane, or triethanol amine or any one of the silane or polysiloxane treatments known to those skilled in the art. Various commercial grades of TiO₂ are suitable pigments, including Ti-Pure® R-960, Ti-Pure® R-706 and TS-6200 (all available from E.I du Pont de Nemours & Co., Wilmington, Del.). In one embodiment, pigments are used in a liquid fluoropolymer coating composition in amounts of from about 1 to about 40 weight percent (wt %) based on fluoropolymer resin solids.

### Dispersing Agents

In one embodiment, a dispersing agent, or dispersant, can be used in a pigment dispersion to aid in the dispersion process and to stabilize the dispersion (e.g., limit the agglomeration of primary particles during storage). In one embodiment, dispersing agents that may be used in pigment dispersions are structured acrylic copolymers (e.g. graft acrylic copolymers or block acrylic copolymers) that are prepared by a controlled polymerization mechanism. Examples of such polymerization mechanisms are controlled free radical polymerization (CFRP) and group transfer polymerization (GTP). Such polymerization technologies lead to tight control of the polymer architecture which helps maximize the dispersing capability of the polymer by providing the best stabilization of the pigment in the dispersing medium. This leads to the ability to maximize the pigment loading in the dispersion and/or minimize its viscosity. Examples of such dispersants are the EFKA®-4300 series (e.g. EFKA®-4320) and analogues (BASF Corp., Dispersions and Pigments North America, Charlotte, N.C.), RK(RCH)-87763, RK-36778 and analogues (Axalta Coating Systems, Philadelphia, Pa.), and Disperbyk 2025 (Byk USA Inc., Wallingford, Conn.). The specific structures of these dispersants are proprietary to the companies that produce them.

While these dispersants are themselves very effective pigment dispersing agents, when used in combination with a viscosity reducing compound, described below, pigment dispersions with higher solids and/or lower pigment dispersion viscosities can be achieved, enabling liquid fluoropolymer coating compositions with higher formulated solids content and/or lower final formulation viscosities.

Those skilled in the art will appreciate that other, more conventional, dispersing agents may likewise show some benefit when used in pigment dispersions in combination with the viscosity reducing compounds described below.

### Viscosity Reducing Compounds

Although dispersing agents may themselves reduce the viscosity of a pigment dispersion, it may be desirable for the viscosity of a pigment dispersion to be even lower before addition to a liquid fluoropolymer coating composition to achieve superior processability of the liquid fluoropolymer coating composition. While it is possible to further reduce viscosity by adding more dispersing agent, larger amounts of dispersant can be detrimental to other properties of the pigment dispersion, liquid fluoropolymer coating composition and/or a fluoropolymer coated film made from the liquid fluoropolymer coating composition. In one embodiment, a further reduction in viscosity of a pigment dispersion and/or a liquid coating composition can be achieved by adding a very small amount of a viscosity reducing compound. In one embodiment, viscosity reducing compounds that may be present in a pigment dispersion or a liquid fluoropolymer coating composition include coupling agents and amines. Coupling agents can include, for example, silane coupling agents, titanate coupling agents and zirconate coupling agents.

In one embodiment, a silane coupling agent for use as a viscosity reducing compound can be a monoalkoxy, dialkoxy or trialkoxy functional silane of the general structure RₙSiX₍₄₋ₙ₎, where n is 1-3, R is a non-hydrolyzable organic moiety and X is a hydrolyzable alkoxy group (e.g., methoxy or ethoxy) as further described by G. L. Witucki in the Journal of Coatings Technology, Vol. 65, No. 822, pgs. 57-60. In a more specific embodiment, a silane coupling agent can be a trialkoxy functional silane of the general structure R²Si(OR¹)₃, where R¹ is a methyl, ethyl or isopropyl group and R² is an organic group (linear, branched, cyclic or aromatic) containing a reactive functional group. A variety of organic groups with reactive functional groups are known. Of particular utility are silanes where the R² group can be described by the formula —(CH₂)ₙY, where n is between 1 and 20, preferably 3, and Y is H, NH₂, NHCH₂CH₂NH₂, NH(CH₂)₃CH₃, a glycidyloxy (epoxy functional) group or other reactive or interactive (e.g. via hydrogen bonding) functional group. Such silanes with a variety of functional groups are available commercially and can be obtained, for example, from Evonik Corporation, Parsippany, N.J. In a specific embodiment, a silane coupling agent can be an amino silane or an epoxy silane. Specific examples of silane coupling agents include 3-aminopropyltrimethoxysilane, 3-aminopropyltriethoxysilane, N-(n-butyl)-3-aminopropyltrimethoxysilane, N-(2-aminoethyl)-3-aminopropyltrimethoxysilane, N-2-(vinylbenzylamino)-ethyl-aminopropyltrimethoxysilane), 3-glycidoxypropyltrimethoxysilane, β-(3,4-epoxycyclohexyl)ethyltrimethoxysilane and mixtures thereof.

In one embodiment, a titanate coupling agent for use as a viscosity reducing compound can include isopropyl tri(dioctyl)phospato titanate, isopropyl tri(N-ethylenediamino)ethyl titanate, neopentyl(diallyl)oxy-tri(m-amino)phenyl titanate, neopentyl(diallyl)oxy-tri(N-ethylenediamino)ethyl titanate, and mixtures thereof. Such titanates are available commercially and can be obtained, for example, from Kenrich Petrochemicals, Inc., Bayonne, N.J.

In one embodiment, a zirconate coupling agent for use as a viscosity reducing compound can be include neopentyl(diallyl)oxy-tri(diactyl)pyro-phosphato zirconate, neopentyl(diallyl)oxy-tri(N-ethylenediamino)ethyl zirconate, neopentyl(diallyl)oxy-tri(m-amino)phenyl zirconate and mixtures thereof. Such zirconates are available commercially and can be obtained, for example, from Kenrich Petrochemicals, Inc.

In one embodiment, an amine for use as a viscosity reducing compound can be a primary amine, a secondary amine, or a tertiary amine. In a specific embodiment, dialkyl and trialkyl amines of the general structure N—R¹R²R³, where R¹ and R² can be a C1-C20 linear, branched or cycloaliphatic hydrocarbon, and R³ can be hydrogen or a C1-C20 linear, branched or cycloaliphatic hydrocarbon can be used. In a more specific embodiment, the amine can be dibutylamine (DBA). In another specific embodiment, an amine may be heterocyclic or aromatic in character. For example, cyclic or bicyclic nitrogen containing compounds such as 4-diazabicyclo[2.2.2]octane (DABCO), diazabicyclo[5.4.0]undec-7-ene (DBU), morpholine, quinuclidine, pyrrolidine and piperazine, of the general structures shown below can be used.

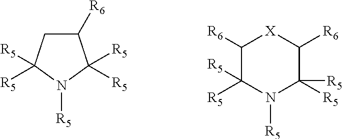

### Where:

R₅ is independently H, Me;
R₆ is H, C1 to C20 linear, branched or cycloaliphatic radical; and

### X is CH₂, O, NR₆.

In another specific embodiment, heterocyclic nitrogen containing compounds of the structure show below can be used.

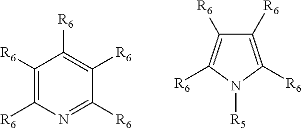

### Where:

R₅ is independently H, Me; and
R₆ is H, C1 to C20 linear, branched or cycloaliphatic radical.

In one embodiment, using viscosity reducing compounds in combination with dispersing agents can prevent dramatic increases in viscosity that can occur when a pigment dispersion is added to a liquid fluoropolymer coating composition. In some embodiments, use of viscosity reducing compounds in combination with dispersing agents can result in liquid fluoropolymer coating compositions that have even lower viscosities than separate pigment dispersion and fluoropolymer dispersion which are combined to form the liquid fluoropolymer coating composition. Depending on the degree of viscosity reduction achieved, coating compositions with significantly higher solids loadings can be used to make fluoropolymer coated films. The choice of viscosity reducing compound will depend on the particular pigment dispersion and/or coating composition employed and the desired effects.

### Pigment Dispersions

Pigments for use in liquid fluoropolymer coating compositions can be employed in the form of a pigment dispersion, in which primary pigment particles are dispersed in an aqueous or non-aqueous liquid. In one embodiment, pigments can be formulated into a millbase by mixing the pigment(s) with a dispersing resin that may be the same as, or compatible with, the fluoropolymer composition into which the pigment is to be incorporated. Pigment dispersions can be formed by conventional means, such as sand grinding, ball milling, attritor grinding or two-roll milling. Other additives, while not generally needed or used, such as fiber glass and mineral fillers, anti-slip agents, plasticizers, nucleating agents, and the like, can also be incorporated.

In one embodiment, a pigment dispersion may have a pigment solids content in the range of from about 50 to about 85 weight percent, or from about 60 to about 80 weight percent or from about 70 to about 75 weight percent. The term “pigment solids content” when used herein is expressed as a weight percentage of the dry pigment particles relative to the overall weight of the pigment dispersion (including both wet and dry components). In one embodiment, the solids weight ratio of the pigment to the viscosity reducing compound in a pigment dispersion may be in the range of from about 10:1 to about 2000:1, or from about 20:1 to about 1000:1, or from about 40:1 to about 500:1.

A wide variety of solvents may be used in a pigment dispersion. The choice depends on the particular pigment being dispersed, the liquid coating composition to which it will be added, the nature of the coating process and other factors. In one embodiment, where TiO₂ is the pigment to be dispersed, solvents may include N-methylpyrrolidone (NMP), dimethyl acetamide (DMAC), propylene carbonate (PC), glycol ethers, such as butyl CELLOSOLVE™, glycol ether acetates, such as butoxy ethyl acetate (BEA) or propylene glycol methyl ether acetate (PMA), ketones, such as methyl isobutyl ketone, esters, such as ethyl acetate, aliphatics, such as napthas and aromatic solvents, such as mixed xylenes.

### Fluoropolymers

Fluoropolymers useful in the fluoropolymer coated film in accordance with one aspect of the invention are selected from homopolymers and copolymers of vinyl fluoride (VF) and homopolymers and copolymers of vinylidene fluoride (VF2). In one embodiment, the fluoropolymer is selected from homopolymers and copolymers of vinyl fluoride comprising at least 60 mole % vinyl fluoride and homopolymers and copolymers of vinylidene fluoride comprising at least 60 mole % vinylidene fluoride. In a more specific embodiment, the fluoropolymer is selected from homopolymers and copolymers of vinyl fluoride comprising at least 80 mole % vinyl fluoride and homopolymers and copolymers of vinyl idene fluoride comprising at least 80 mole % vinylidene fluoride. Blends of the fluoropolymers with non-fluoropolymers, e.g., acrylic polymers, may also be suitable for the practice of some aspects of the invention. Homopolymer polyvinyl fluoride (PVF) and homopolymer polyvinylidene fluoride (PVDF) are well suited for the practice of specific aspects of the invention. Fluoropolymers selected from homopolymer polyvinyl fluoride and copolymers of vinyl fluoride are particularly effective for the practice of the present invention.

In one embodiment, with VF copolymers or VF2 copolymers, comonomers can be either fluorinated or nonfluorinated or combinations thereof. By the term “copolymers” is meant copolymers of VF or VF2 with any number of additional fluorinated or non-fluorinated monomer units so as to form dipolymers, terpolymers, tetrapolymers, etc. If nonfluorinated monomers are used, the amount used should be limited so that the copolymer retains the desirable properties of the fluoropolymer, i.e., weather resistance, solvent resistance, barrier properties, etc. In one embodiment, fluorinated comonomers are used including fluoroolefins, fluorinated vinyl ethers, or fluorinated dioxoles. Examples of useful fluorinated comonomers include tetrafluoroethylene (TFE), hexafluoropropylene (HFP), chlorotrifluoroethylene (CTFE), trifluoroethylene, hexafluoroisobutylene, perfluorobutyl ethylene, perfluoro (propyl vinyl ether) (PPVE), perfluoro (ethyl vinyl ether) (PEVE), perfluoro (methyl vinyl ether) (PMVE), perfluoro-2,2-dimethyl-1,3-dioxole (PDD) and perfluoro-2-methylene-4-methyl-1,3-dioxolane (PMD) among many others.

Homopolymer PVDF coatings can be formed from a high molecular weight PVDF. Blends of PVDF and alkyl (meth)acrylate polymers can be used. Polymethyl methacrylate is particularly desirable. Typically, these blends can comprise 50-90% by weight of PVDF and 10-50% by weight of alkyl (meth)acrylate polymers, in a specific embodiment, polymethyl methacrylate. Such blends may contain compatibilizers and other additives to stabilize the blend. Such blends of polyvinylidene fluoride, or vinylidene fluoride copolymer, and acrylic resin as the principal components are described in U.S. Pat. Nos. 3,524,906; 4,931,324; and 5,707,697.

Homopolymer PVF coatings can be formed from a high molecular weight PVF. Suitable VF copolymers are taught by U.S. Pat. Nos. 6,242,547 and 6,403,740 to Uschold.

### Compatible Cross-Linkable Adhesive Polymers and Cross-Linking Agents

The compatible cross-linkable adhesive polymers employed in the fluoropolymer coated film according to one aspect of the invention comprise functional groups selected from amine, isocyanate, hydroxyl and combinations thereof. In one embodiment, the compatible cross-linkable adhesive polymer has (1) a backbone composition that is compatible with the fluoropolymer in the composition and (2) pendant functionality capable of reacting with complementary functional groups on a substrate film surface. The compatibility of the cross-linkable adhesive polymer backbone with the fluoropolymer will vary but is sufficient so that the compatible cross-linkable adhesive polymer can be introduced into the fluoropolymer in the desired amount to secure the fluoropolymer coating to the polymeric substrate film. In general however, homo and copolymers derived largely from vinyl fluoride and vinylidene fluoride will show compatibility characteristics that will favor acrylic, urethane, aliphatic polyester, polyester urethane, polyether, ethylene vinyl alcohol copolymer, amide, acrylamide, urea and polycarbonate backbones having the functional groups described above.

In a specific embodiment, where the polymeric substrate film is an unmodified polyester with intrinsic hydroxyl and carboxylic acid functional groups (e.g., adventitious surface groups or chain ends), reactive polyols (e.g., polyester polyols, polycarbonate polyols, acrylic polyols, polyether polyols, etc.) can be used as the compatible cross-linkable adhesive polymer in the presence of an appropriate cross-linking agent (e.g., an isocyanate functional compound or a blocked isocyanate functional compound) to bond the fluoropolymer coating to the polymeric substrate film. The bonding may occur through the functional groups of the reactive polyols, the cross-linking agent, or both. Upon curing, a cross-linked adhesive polymer, such as a cross-linked polyurethane network is formed as an interpenetrating network with the fluoropolymer in the coating. In addition, it is believed that the cross-linked polyurethane network also provides the functionality that bonds the fluoropolymer coating to the polyester substrate film.

Those skilled in the art will understand that choices for compatible cross-linkable adhesive polymers and cross-linking agents can be based on compatibility with the fluoropolymer, compatibility with the selected fluoropolymer solution or dispersion, their compatibility with the processing conditions for forming the fluoropolymer coating on the selected polymeric substrate film, their ability to form cross-linked networks during formation of the fluoropolymer coating, and/or the compatibility of their functional groups with those of the polymeric substrate film in forming bonds that provide strong adherence between the fluoropolymer coating and the polymeric substrate film.

### Catalyst Systems

Addition of a suitable catalyst system can accelerate the rate of reaction in order to achieve a commercially viable process. In one embodiment, a catalyst may be an organotin compound. Examples of suitable organotin compounds include dibutyl tin dilaurate (DBTDL), dibutyl tin dichloride, stannous octanoate, dibutyl tin dilaurylmercaptide and dibutyltin diisooctylmaleate.

In one embodiment, the catalyst is a mixed catalyst. The term “mixed catalyst” when used herein, refers to a catalyst system in which at least two different compounds act as catalysts for chemical reaction in a single system. In one embodiment of a mixed catalyst system, a main catalyst may be an organotin compound, and a co-catalyst may be selected from the group consisting of organozincs, organobismuths, and mixtures thereof. Suitable organotin compounds include, but are not limited to, dibutyl tin dilaurate (DBTDL), dibutyl tin dichloride, stannous octanoate, dibutyl tin dilaurylmercaptide and dibutyltin diisooctylmaleate.

In one embodiment, wherein the co-catalyst includes an organozinc compound, the co-catalyst can include a zinc carboxylate or an organozinc acetylacetone complex. Examples of suitable organozinc compounds include zinc acetylacetonate, zinc neodecanoate, zinc octanoate and zinc oleate. Suitable organozinc compounds also include BiCAT® 3228 and BiCAT® Z (The Shepherd Chemical Co., Norwood, Ohio).

In another embodiment, wherein the co-catalyst includes an organobismuth compound, the co-catalyst can include an organobismuth carboxylate complex. Examples of suitable organobismuth compounds include K-KAT 348 and K-KAT 628 (King Industries, Inc. Norwalk, Conn.), and BiCAT® 8, BiCAT® 8106, BiCAT® 8108 and BiCAT® 8210 (Shepherd Chemical).

Numerous combinations of organotin catalysts with co-catalysts comprising organozincs, organobismuths, and mixtures thereof may be useful in the liquid fluoropolymer coating compositions described herein. Those skilled in the art will be able to select an appropriate mixed catalyst system based on the properties of the polymer system being used in the process and the desired properties of the final fluoropolymer coated film.

### UV Additives and Thermal Stabilizers

In one embodiment, the fluoropolymer coating compositions may contain one or more light stabilizers as additives. Light stabilizer additives include compounds that absorb ultraviolet radiation such as hydroxybenzophenones, hydroxyphenyl-triazines and hydroxybenzotriazoles. Other possible light stabilizer additives include hindered amine light stabilizers (HALS) and antioxidants. Thermal stabilizers (e.g., triphenyl phosphite) can also be used, if desired.

### Barrier Particles

In one embodiment, the fluoropolymer coating composition may include barrier particles. In a specific embodiment, the particles may be platelet-shaped particles. Such particles tend to align during application of the coating and, since water, solvent and gases such as oxygen cannot pass readily through the particles themselves, a mechanical barrier is formed in the resulting coating which reduces permeation of water, solvent and gases. In a photovoltaic module, for example, the barrier particles substantially increase the moisture barrier properties of the fluoropolymer and enhance the protection provided to the solar cells. In some embodiments, barrier particles are present in amounts of from about 0.5 to about 10% by weight based on the total dry weight of the fluoropolymer resin solids in the coating.

Examples of typical platelet shaped filler particles include mica, talc, clay, glass flake, stainless steel flake and aluminum flake. In one embodiment, the platelet shaped particles are mica particles, including mica particles coated with an oxide layer such as iron or titanium oxide. In some embodiments, these particles have an average particle size of about 10 to 200 μm, or 20 to 100 μm, with no more than 50% of the particles of flake having average particle size of more than about 300 μm. The mica particles coated with an oxide layer are described in U.S. Pat. No. 3,087,827 (Klenke and Stratton); U.S. Pat. No. 3,087,828 (Linton); and U.S. Pat. No. 3,087,829 (Linton). The micas described in these patents are coated with oxides or hydrous oxides of titanium, zirconium, aluminum, zinc, antimony, tin, iron, copper, nickel, cobalt, chromium, or vanadium. Mixtures of coated micas can also be used.

### Liquid Fluoropolymer Coating Compositions

The liquid fluoropolymer coating compositions may contain the fluoropolymer either in the form of a solution or dispersion of the fluoropolymer. Typical solutions or dispersions for the fluoropolymer are prepared using solvents which have boiling points high enough to avoid bubble formation during the film forming/drying process. For polymers in dispersion form, a solvent which aids in coalescence of the fluoropolymer is desirable. The polymer concentration in these solutions or dispersions is adjusted to achieve a workable viscosity of the solution and will vary with the particular polymer, the other components of the coating composition, and the process equipment and conditions used. In one embodiment, for solutions, the fluoropolymer is present in an amount of about 10 wt % to about 25 wt % based on the total weight of the liquid fluoropolymer coating composition. In another embodiment, for dispersions, the fluoropolymer is present in an amount of about 25 wt % to about 50 wt % based on the total weight of the liquid fluoropolymer coating composition.

The form of the polymer in the liquid fluoropolymer coating composition is dependent upon the type of fluoropolymer and the solvent used. Homopolymer PVF is normally in dispersion form. Homopolymer PVDF can be in dispersion or solution form dependent upon the solvent selected. For example, homopolymer PVDF can form stable solutions at room temperature in many polar organic solvents such as amides, ketones, esters and some ethers. Suitable examples include acetone, methylethyl ketone (MEK), N-methylpyrrolidone (NMP), dimethyl acetamide (DMAC), and tetrahydrofuran (THF). Depending upon comonomer content and the solvent selected, copolymers of VF and VF2 may be used either in dispersion or solution form.

In one embodiment, using homopolymer polyvinyl fluoride (PVF), suitable coating formulations are prepared using dispersions of the fluoropolymer. The nature and preparation of dispersions are described in detail in U.S. Pat. Nos. 2,419,008; 2,510,783; and 2,599,300. In a specific embodiment, PVF dispersions are formed in propylene carbonate (PC), γ-butyrolactone (GBL), NMP, DMAC or dimethylsulfoxide (DMSO). In addition, these dispersions may contain co-solvents, such as BEA, PMA or others to facilitate the coating process.

To prepare the liquid fluoropolymer coating composition in dispersion form, the fluoropolymer may be milled in a suitable solvent. Separately, the pigment dispersion along with the dispersing agent may be milled before mixing with the fluoropolymer, the compatible cross-linkable adhesive polymer, the cross-linking agent, the catalyst and any other components that may be used in the coating composition. The viscosity reducing compound may be present in the pigment dispersion during milling of the pigment dispersion, or it may be introduced as part of the liquid fluoropolymer coating composition along with the other components that are not part of the pigment dispersion. Components which are soluble in the solvent do not require milling.

A wide variety of mills can be used for the preparation of both the pigment and fluoropolymer dispersions. Typically, the mill employs a dense agitated grinding medium, such as sand, steel shot, glass beads, ceramic shot, Zirconia, or pebbles, as in a ball mill, an ATTRITOR® available from Union Process, Akron, Ohio, or an agitated media mill such as a “Netzsch” mill available from Netzsch, Inc., Exton, Pa. The fluoropolymer dispersion is milled for a time sufficient to cause de-agglomeration of the PVF particles. Typical residence time of the dispersion in a Netzsch mill ranges from thirty seconds up to ten minutes. Milling conditions of the fluoropolymer dispersion (e.g., temperature) are controlled to avoid swelling or gelation of the fluoropolymer particles.

The compatible cross-linkable adhesive polymer is employed in the liquid fluoropolymer coating composition at a level sufficient to provide the desired bonding to the polymeric substrate film but below the level at which the desirable properties of the fluoropolymer would be significantly adversely affected. In one embodiment, the liquid fluoropolymer coating composition contains from about 1 to about 40 wt % compatible cross-linkable adhesive polymer, or from about 1 to about 25 wt %, or from about 1 to about 20 wt %, based on the weight of the fluoropolymer.

The cross-linking agent is employed in the liquid fluoropolymer coating composition at a level sufficient to provide the desired cross-linking of the compatible cross-linkable adhesive polymer. In one embodiment, the liquid coating composition contains from about 50 to about 400 mole % cross-linking agent per molar equivalent of cross-linkable adhesive polymer, or from about 75 to about 200 mole %, or from about 125 to about 175 mole %.

Catalyst may be employed in the liquid coating fluoropolymer composition to improve the process kinetics. The amount of catalyst used is typically kept to a minimum to limit any negative effects on long term adhesion between polymeric substrate films and fluoropolymer coatings formed using the liquid coating composition. In one embodiment, an organotin catalyst may be used and can be present in a range of from about 0.05 to about 1.0 parts per hundred (pph), dry basis, of catalyst to fluoropolymer resin solids, or from about 0.1 to about 0.5 pph, or from about 0.1 to about 0.2 pph.

In one embodiment, a mixed catalyst system can be used. When incorporating a mixed catalyst into the liquid fluoropolymer coating composition, an organotin catalyst can be used as a main catalyst, and can be present in a range of from about 0.005 to about 0.1 parts per hundred (pph), dry basis, of main catalyst to fluoropolymer resin solids, or from about 0.01 to about 0.05 pph, or from about 0.01 to about 0.02 pph. In one embodiment, the co-catalyst can be an organobismuth compound or an organozinc compound and can be present in a range of from about 0.05 to about 1.0 pph, dry basis, of co-catalyst to fluoropolymer resin solids, or from about 0.1 to about 0.5 pph, or from about 0.1 to about 0.2 pph.

The solids weight ratio of main catalyst to co-catalyst used in a mixed catalyst system can vary over a broad range. In one embodiment, the solids weight ratio of main catalyst to co-catalyst can be in a range of from about 0.005:1 to about 200:1, or from about 0.05:1 to about 50:1, or from about 0.1:1 to about 2:1.

The amount of catalyst used, and in the case of a mixed catalyst system, the solids weight ratio of main catalyst to co-catalyst in the mixed catalyst, will affect the cure time needed to produce good adhesion of a fluoropolymer coating to a polymeric substrate film.

Pigment, in the form of a dispersion, can be added to the liquid fluoropolymer coating composition to provide the final dry film with a desired color and opacity. In one embodiment, where the pigment is TiO₂, the pigment improves the UV resistance and opacity of the dry film. During the addition of a pigment dispersion to a liquid fluoropolymer coating composition, however, there can be a large and undesirable viscosity increase. This large viscosity increase can make the liquid fluoropolymer coating composition more difficult to apply, requiring additional solvent addition to the resultant mix. This reduces productivity and increases cost and environmental impact of the coating mix. Using dispersing agents in the pigment dispersion can help reduce the viscosity of the liquid coating composition to more desirable levels.

In one embodiment, even greater viscosity reduction can be achieved by using a viscosity reducing compound in conjunction with a dispersing agent. Pigment dispersions with higher solids and/or lower pigment dispersion viscosities can be achieved, enabling liquid fluoropolymer coating compositions with higher formulated solids content and/or lower final formulation viscosities. The amount of viscosity reducing compound is typically kept to a minimum because extra additive can make the viscosity too low for proper coating and can also have negative effects on adhesion. In one embodiment, the viscosity reducing compound can be present in the range of from about 0.001 to about 1.0 wt % in the liquid fluoropolymer coating composition (weight percentage of viscosity reducing compound based on the overall weight of the liquid fluoropolymer coating composition), or from about 0.01 to about 0.1 wt %, or from about 0.02 to about 0.05 wt %.

In one embodiment, a liquid fluoropolymer coating compositions may have an overall solids content in the range of from about 10 to about 60 weight percent, or from about 20 to about 50 weight percent, or from about 30 to about 45 weight percent. The term “overall solids content” when used herein is expressed as a weight percentage of the dry solids in the coating composition relative to the overall weight of the liquid fluoropolymer coating compositions (including both wet and dry components). In one embodiment, the solids weight ratio of the pigment to the viscosity reducing compound in a liquid fluoropolymer coating compositions may be in the range of from about 10:1 to about 2000:1, or from about 20:1 to about 1000:1, or from about 40:1 to about 500:1.

### Polymeric Substrate Films

Polymeric substrate films may be selected from a wide range of polymers, with thermoplastics being desirable for their ability to withstand higher processing temperatures. The polymeric substrate film comprises functional groups on its surface that interact with the compatible cross-linkable adhesive polymer, the cross-linking agent, or both, to promote bonding of the fluoropolymer coating to the polymeric substrate film. In one embodiment, the polymeric substrate film is a polyester, a polyamide or a polyimide. In a specific embodiment, a polyester for the polymeric substrate film is selected from polyethylene terephthalate, polyethylene naphthalate and a co-extrudate of polyethylene terephthalate/polyethylene naphthalate.

Fillers may also be included in the substrate film, where their presence may improve the physical properties of the substrate, for example, higher modulus and tensile strength. They may also improve adhesion of the fluoropolymer coating to the polymeric substrate film. One exemplary filler is barium sulfate, although others may also be used.

The surface of the polymeric substrate film which is to be coated may naturally possess some functional groups suitable for bonding, as in hydroxyl and/or carboxylic acid groups in a polyester film, or amine and/or acid functionality in a polyamide film. The presence of these intrinsic functional groups on the surface of a polymeric substrate film clearly provide commercial benefits by simplifying the process of bonding a coating onto the polymeric substrate film to form a fluoropolymer coated film. The invention employs compatible cross-linkable adhesive polymers and/or cross-linking agents in the coating composition that may take advantage of the intrinsic functionality of the polymeric substrate film. In this way, an unmodified polymeric substrate film can be chemically bonded to a fluoropolymer coating (i.e., without the use of separate primer layers or adhesives or separate surface activation treatments) to form a fluoropolymer coated film with excellent adhesion. The term “unmodified polymeric substrate film” as used herein means polymeric substrates which do not include primer layers or adhesives and which do not include surface treatment or surface activation such as are described in the following paragraph. In addition, an unprimed polymeric substrate film can be chemically bonded to a fluoropolymer coating to form a fluoropolymer coated film with excellent adhesion. The term “unprimed polymeric substrate film” as used herein means polymeric substrates which do not include primer layers but may include surface treatment or surface activation such as are described in the following paragraph.

Many polymeric substrate films may need or would further benefit from modifying to provide additional functional groups suitable for bonding to the fluoropolymer coating, however, and this may be achieved by surface treatment, or surface activation. That is, the surface can be made more active by forming functional groups of carboxylic acid, sulfonic acid, aziridine, amine, isocyanate, melamine, epoxy, hydroxyl, anhydride and/or combinations thereof on the surface. In one embodiment, the surface activation can be achieved by chemical exposure, such as to a gaseous Lewis acid such as BF₃ or to sulfuric acid or to hot sodium hydroxide. Alternatively, the surface can be activated by exposing one or both surfaces to an open flame while cooling the opposite surface. Surface activation can also be achieved by subjecting the film to a high frequency, spark discharge such as corona treatment or atmospheric nitrogen plasma treatment. Additionally, surface activation can be achieved by incorporating compatible comonomers into the polymeric substrate when forming a film. Those skilled in the art, will appreciate the wide variety of processes that may be used to form compatible functional groups on the surface of a polymeric substrate film.

In addition, modifying to provide additional functional groups suitable for bonding to the fluoropolymer coating may be performed by applying a primer layer to the surface of the polymeric substrate film to increase its surface functionality, as described in U.S. Pat. No. 7,553,540, DeBergalis et al., which is incorporated herein by reference in its entirety.

### Coating Application

The fluoropolymer compositions for making the fluoropolymer coated film in accordance with one aspect of the present invention can be applied as a liquid directly to suitable polymeric substrate films by conventional coating means with no need to form a preformed film. Techniques for producing such coatings include conventional methods of casting, dipping, spraying and painting. When the fluoropolymer coating contains fluoropolymer in dispersion form, it is typically applied by casting the dispersion onto the substrate film, using conventional means, such as spray, roll, knife, curtain, gravure coaters, slot-die or any other method that permits the application of a uniform coating without streaks or other defects. In one embodiment, the dry coating thickness of a cast dispersion is between about 1 μm (0.04 mil) and about 250 μm (10 mils), and in a more specific embodiment, between about 2 μm (0.08 mil) and about 50 μm (2 mils), and in an even more specific embodiment, between about 6 μm (0.25 mil) and about 30 μm (1.25 mil).

After application, the compatible cross-linkable adhesive polymer is cross-linked to form a compatible cross-linked adhesive polymer, the solvent is removed, and the fluoropolymer coating is adhered to the polymeric substrate film. With some compositions in which the fluoropolymer is in solution form, the liquid fluoropolymer coating compositions can be coated onto polymeric substrate films and allowed to air dry at ambient temperatures. Although not necessary to produce a coalesced film, heating is generally desirable to cross-link the compatible cross-linkable adhesive polymer and to dry the fluoropolymer coating more quickly. Cross-linking the compatible cross-linkable adhesive polymer, removing of the solvent, and adhering of the fluoropolymer coating to the polymeric substrate can be achieved in a single heating or by multiple heatings. Drying temperatures are in the range of about 25° C. (ambient conditions) to about 220° C. (oven temperature—the film temperature will be lower). The temperature used should also be sufficient to promote the interaction of the functional groups in the compatible cross-linkable adhesive polymer and/or cross-linking agent with the functional groups of the polymeric substrate film to provide secure bonding of the fluoropolymer coating to the polymeric substrate film. This temperature varies widely with the compatible cross-linkable adhesive polymer and cross-linking agent employed and the functional groups of substrate film. The drying temperature can range from room temperature to oven temperatures in excess of that required for the coalescence of fluoropolymers in dispersion form as discussed below.

When the fluoropolymer in the composition is in dispersion form, it is necessary for the solvent to be removed, for cross-linking of the compatible adhesive polymer to occur, and also for the fluoropolymer to be heated to a sufficiently high temperature that the fluoropolymer particles coalesce into a continuous film. In addition, bonding to the polymeric substrate film is desired. In one embodiment, fluoropolymer in the coating is heated to a cure temperature of about 150° C. to about 250° C. The solvent used desirably aids in coalescence, i.e., enables a lower temperature to be used for coalescence of the fluoropolymer coating than would be necessary with no solvent present. Thus, the conditions used to coalesce the fluoropolymer will vary with the fluoropolymer used, the solvent chosen, the thickness of the cast dispersion and the substrate film, and other operating conditions. For homopolymer PVF coatings and residence times of about 1 to about 3 minutes, oven temperatures of from about 340° F. (171° C.) to about 480° F. (249° C.) can be used to coalesce the film, and temperatures of about 380° F. (193° C.) to about 450° F. (232° C.) have been found to be particularly satisfactory. The oven air temperatures, of course, are not representative of the temperatures reached by the fluoropolymer coating which will be lower.

Formation of a cross-linked network of compatible cross-linked adhesive polymer in the presence of the coalescing fluoropolymer can result in the formation of interpenetrating networks of compatible cross-linked adhesive polymer and fluoropolymer, creating an interlocked network. Thus, even if there is segregation or phase separation of the two polymer networks within the fluoropolymer coating and an absence of chemical bonding between the two networks, a strong durable coating is still formed. As long as there is adequate bonding between the compatible cross-linked adhesive polymer and the polymeric substrate film, excellent adhesion between the layers of the fluoropolymer coated film can be attained.

The fluoropolymer coating composition is applied to a polymeric substrate film. In one embodiment, the polymeric substrate film is polyester, polyamide, or polyimide. In a specific embodiment, the polymeric substrate film is polyester such as polyethylene terephthalate, polyethylene naphthalate or a co-extrudate of polyethylene terephthalate/polyethylene naphthalate. In another embodiment, the fluoropolymer coating is applied to both surfaces of the substrate film. This can be performed simultaneously on both sides of the polymeric substrate film or alternatively, the coated substrate film can be dried, turned to the uncoated side and resubmitted to the same coating head to apply coating to the opposite side of the film to achieve coating on both sides of the film.

### Photovoltaic Modules

Fluoropolymer coated films are especially useful in photovoltaic modules. A typical construction for a photovoltaic module includes a thick layer of glass as a glazing material. The glass protects solar cells comprising crystalline silicon wafers and wires which are embedded in a moisture resisting plastic sealing compound such as cross-linked ethylene vinyl acetate. Alternatively thin film solar cells can be applied from various semiconductor materials, such as CIGS (copper-indium-gallium-selenide), CdTe (cadmium telluride), CTS (copper-tin-sulfide), CZTS (copper-zinc-tin-sulfide), a-Si (amorphous silicon) and others on a carrier sheet which is also jacketed on both sides with encapsulant materials. Adhered to the encapsulant is a backsheet. Fluoropolymer coated films are useful for such backsheets. The fluoropolymer coating comprises fluoropolymer selected from homopolymers and copolymers of vinyl fluoride and homopolymers and copolymers of vinylidene fluoride polymer blended with compatible cross-linkable adhesive polymer containing functional groups selected from carboxylic acid, sulfonic acid, aziridine, anhydride, amine, isocyanate, melamine, epoxy, hydroxyl, and combinations thereof. The polymeric substrate film comprises functional groups on its surface that interact with the compatible cross-linkable adhesive polymer to promote bonding of the fluoropolymer coating to the substrate film. In one embodiment, the polymeric substrate film is a polyester, and in a more specific embodiment, a polyester selected from the group consisting of polyethylene terephthalate, polyethylene naphthalate and a co-extrudate of polyethylene terephthalate/polyethylene naphthalate. Polyester provides electrical insulation and moisture barrier properties, and is an economical component of the backsheet. In some embodiments, both surfaces of the polymeric substrate film are coated with fluoropolymer creating a sandwich of polyester between two layers of coating of fluoropolymer. Fluoropolymer films provide excellent strength, weather resistance, UV resistance, and moisture barrier properties to the backsheet.

### EXAMPLES

The concepts described herein will be further described in the following examples, which do not limit the scope of the invention described in the claims.

### Test Methods

### Viscosity

Viscosity is measured using a Brookfield DV-II+ Pro Viscometer (Brookfield Engineering Laboratories, Inc., Middleboro, Mass.), which measures fluid viscosity at given shear rates by rotating a spindle immersed in a test fluid. By using spindles of differing size and shape, the shear rate in the fluid can be changed. At very low shear rates, viscosity differences between different fluids are more pronounced, but if the viscosity is too low, there is not enough torque on the rotating spindle and the accuracy of the measurement will be low. Conversely, if the viscosity is too high, there may be too much torque on the spindle, and the measurement may once again be beyond to range of accurate measurement. Hence, it is necessary to choose an appropriate spindle and rotation speed to improve the accuracy of the viscosity measurement.

### 180 Degree Peel Strength

Peel strength is measured using an Instron® Model 3345 Single Column Testing System (Instron, Norwood, Mass.) pulling at 10 inches per minute, recording the peak value and averaging 3 samples (following the procedure in ASTM D1876-01 T-Peel Test). If a sample could not be cleanly pulled without the coating tearing, it was assigned a value of 6 N/cm, the maximum force which was able to be measured for a 25 μm coating.

### Initial Adhesion Peel Test

Samples were precision precut into ½ inch strips. The strips were tested for adhesion by placing a piece of 8981 Scotch® Strapping Tape (3M, St. Paul, Minn.) on the side to be peeled and cutting the back side of the film. The film was snapped and the tape used to help start the peel. Well adhering samples tore immediately, those with good, but non-measureable, adhesion tore where the tape backing ended. Finally, samples that did not tear (which were peeling only) were placed in the Instron® Model 3345 and measured according to ASTM D1876-01.

### Autoclave Exposed Peel Test

Samples were precision precut into ½ inch strips prior to insertion into an autoclave at 105° C. and 5 psig steam pressure. After removal from the autoclave, the strips were tested for adhesion using the method described above for initial adhesion.

### Examples 1-2 and Comparative Examples 1-2

Examples 1-2 demonstrate the synergistic benefit of using both a dispersing agent and a viscosity reducing compound in a pigment dispersion.

For Comparative Example 1 (CE1), a 70 wt % solids pigment dispersion (based on pigment solids only) was made with a 50:1 weight ratio of pigment to dispersing agent. Into a 500 ml wide mouth plastic bottle equipped with a propeller type, air-driven, mechanical stirrer were charged 141.2 g of butoxy ethyl acetate (BEA, butyl CELLOSOLVE™ acetate, Dow Chemical Co., Midland, Mich.) and 14.8 g of EFKA®4320 dispersant (50% solids in propylene glycol methyl ether acetate (PMA) solvent, BASF). After thorough mixing, 370 g of Ti-Pure® R-960 TiO₂ powder (DuPont) was added in several portions with vigorous mixing. After the TiO₂ addition was complete, the mixture was allowed to stir for approximately another 30 minutes and then the bottle was capped and placed securely inside a metal paint can then on a paint shaker and allowed to shake vigorously for 10 minutes. The viscosity of the resulting TiO₂ dispersion was measured to be about 370 centipoise (cps) on the Brookfield DV-II+ Pro Viscometer, using an RV #4 spindle at 100 rpm, 25° C.

For Comparative Example 2 (CE2), a 70 wt % solids pigment dispersion was made with a 50:1 weight ratio of pigment to viscosity reducing compound. In a similar manner to CE1, 7.4 g of N-(n-butyl)-3-aminopropyltrimethoxysilane (Dynasylan® 1189, Evonik Industries, Parsippany, N.J.) were dissolved into 146.8 g of BEA along with 1.8 g of deionized water (three times the moles of the silane to facilitate hydrolysis of the silane alkoxy groups to silanols), followed by the portion-wise addition of the 370 g TiO₂. The resulting pigment dispersion was quite viscous exhibiting a Brookfield viscosity of 7648 cps using an RV #5 spindle at 50 rpm, 25° C.

For Example 1 (E1), a 70 wt % solids pigment dispersion was made with a 50:1 weight ratio of pigment to the combined weight of the dispersing agent and the viscosity reducing compound. The ratio of the dispersing agent to the viscosity reducing compound was 1:1. In a similar manner to CE1, 7.4 g of EFKA® 4320 and 3.7 g of Dynasylan® 1189 were dissolved into 144.0 g of BEA along with 0.9 g of deionized water, followed by the portion-wise addition of the 370 g TiO₂. The resulting pigment dispersion exhibited a Brookfield viscosity of only 113 cps using an RV #3 spindle at 100 rpm, 25° C., lower than that of both CE1 (no viscosity reducing compound) and CE2 (no dispersing agent).

For Example 2 (E2), a 70 wt % solids pigment dispersion was made with a 50:1 weight ratio of pigment to the combined weight of the dispersing agent and the viscosity reducing compound. The ratio of the dispersing agent to the viscosity reducing compound was 3:1. In a similar manner to CE1, 11.1 g of EFKA® 4320 and 1.85 g of Dynasylan® 1189 were dissolved into 142.6 g of BEA along with 0.45 g of deionized water, followed by the portion-wise addition of the 370 g TiO₂. The resulting pigment dispersion exhibited a Brookfield viscosity of only 134 cps using an RV #3 spindle at 100 rpm, 25° C., lower than that of both CE1 (no viscosity reducing compound) and CE2 (no dispersing agent). E2 further demonstrates that even at lower levels of viscosity reducing compound, the synergistic benefit of the combination of dispersing agent and viscosity reducing compound is maintained.

### Examples 3-4 and Comparative Example 3

Examples 3-4 demonstrate the synergistic benefit of using both a dispersing agent and a viscosity reducing compound in a pigment dispersion at higher solids loading and using different dispersion solvents.

For Comparative Example 3 (CE3), a 78 wt % solids pigment dispersion was made with a 25:1 weight ratio of pigment to dispersing agent.

In a similar manner to CE1, but on a larger scale, into a 1 L wide mouth plastic bottle with air-driven propeller type mechanical stirrer, 98.5 g of EFKA® 4320 were dissolved into 248.7 g of BEA, followed by the portion-wise addition of the 1230.8 g TiO₂. The resulting highly viscous pigment dispersion exhibited a Brookfield viscosity of 21640 cps using an RV #5 spindle at 10 rpm, 23° C.

For Example 3 (E3), a 78 wt % solids pigment dispersion was made with a 25:1 weight ratio of pigment to the combined weight of the dispersing agent and the viscosity reducing compound. The ratio of the dispersing agent to the viscosity reducing compound was 3:1. In a similar manner to CE3, 73.9 g of EFKA® 4320 and 12.31 g of Dynasylan® 1189 were dissolved into 258.2 g of BEA along with 2.81 g of deionized water, followed by the portion-wise addition of the 1230.8 g TiO₂. The resulting pigment dispersion exhibited a Brookfield viscosity of 2196 cps using an RV #5 spindle at 100 rpm, 23° C. Even at higher solids loading, the synergistic benefit of the combination of dispersing agent and viscosity reducing compound is maintained. In addition, E3 demonstrates that these benefits are maintained in a larger scale preparation.

For Example E4 (E4), a 78 wt % solids pigment dispersion was made with a 25:1 weight ratio of pigment to the combined weight of the dispersing agent and the viscosity reducing compound. The ratio of the dispersing agent to the viscosity reducing compound was 3:1. In a similar manner to CE3, 22.2 g of EFKA® 4320 and 3.7 g of Dynasylan® 1189 were dissolved into 65.7 g of PMA along with 0.9 g of deionized water, followed by the portion-wise addition of the 370 g TiO₂. This dispersion had a solids content of 80 wt % and the viscosity was quite high, so an additional 11.9 g of PMA was added (bringing the solids content down to 78 wt %) and the dispersion was further shaken to yield a thick, but flowable, dispersion. The resulting pigment dispersion exhibited a Brookfield viscosity of 1440 cps using an RV #53 spindle at 100 rpm, 25° C.

### Examples 5-9 and Comparative Example 4

Examples 5-9 demonstrate the synergistic benefit of using both a dispersing agent and a viscosity reducing compound in a pigment dispersion using different dispersing agents and viscosity reducing compounds, as well as different ratios of pigment to the combined weight of the dispersing agent and the viscosity reducing compound.

For Comparative Example 4 (CE4), a 70 wt % solids pigment dispersion was made with a 25:1 weight ratio of pigment to dispersing agent. In a similar manner to CE1, 34.4 g of RK-36778 dispersant (˜41% solids, Axalta) were dissolved into 121.6 g of BEA, followed by the portion-wise addition of the 370 g TiO₂. The resulting pigment dispersion exhibited a Brookfield viscosity of 188 cps using an RV #3 spindle at 100 rpm, 25° C.

For Example 5 (E5), a 70 wt % solids pigment dispersion was made with a 50:1 weight ratio of pigment to the combined weight of the dispersing agent and the viscosity reducing compound. The ratio of the dispersing agent to the viscosity reducing compound was 1:1. In a similar manner to CE4, 9.0 g of RK-36778 dispersant and 3.70 g of Dynasylan® 1189 were dissolved into 142.4 g of BEA along with 0.85 g of deionized water, followed by the portion-wise addition of the 370 g TiO₂. The resulting pigment dispersion exhibited a Brookfield viscosity of 176 cps using an RV #2 spindle at 100 rpm, 25° C.

For Example 6 (E6), a 70 wt % solids pigment dispersion was made with a 33:1 weight ratio of pigment to the combined weight of the dispersing agent and the viscosity reducing compound. The ratio of the dispersing agent to the viscosity reducing compound was 2:1. In a similar manner to CE4, 18.0 g of RK-36778 dispersant and 3.70 g of Dynasylan® 1189 were dissolved into 133.4 g of BEA along with 0.85 g of deionized water, followed by the portion-wise addition of the 370 g TiO₂. The resulting pigment dispersion exhibited a Brookfield viscosity of 135 cps using an RV #2 spindle at 100 rpm, 25° C. Even though the weight ratios of pigment to the combined weight of the dispersing agent and the viscosity reducing compound in E5 (50:1) and E6 (33:1) are higher than the weight ratio of pigment to dispersing agent in CE4 (25:1), which has no viscosity reducing compound, the viscosities of E5 and E6 are still lower than that of CE4, further demonstrating the synergistic benefit of the combination of dispersing agent and viscosity reducing compound.

For Example 7 (E7), a 70 wt % solids pigment dispersion was made with a 33:1 weight ratio of pigment to the combined weight of the dispersing agent and the viscosity reducing compound. The ratio of the dispersing agent to the viscosity reducing compound was 2:1. In a similar manner to CE4, 18.0 g of RK-36778 dispersant and 3.70 g of 3-glycidoxypropyltrimethoxysilane (Dynasylan® GLYMO, Evonik) were dissolved into 133.4 g of BEA along with 0.85 g of deionized water, followed by the portion-wise addition of the 370 g TiO₂. The resulting pigment dispersion exhibited a Brookfield viscosity of 126 cps using an RV #2 spindle at 100 rpm, 25° C.

For Example 8 (E8), a 70 wt % solids pigment dispersion was made with a 33:1 weight ratio of pigment to the combined weight of the dispersing agent and the viscosity reducing compound. The ratio of the dispersing agent to the viscosity reducing compound was 2:1. In a similar manner to CE4, 18.0 g of RK-36778 dispersant and 3.70 g of Dynasylan® GLYMO were dissolved into 133.4 g of BEA with no added water, followed by the portion-wise addition of the 370 g TiO₂. The resulting pigment dispersion exhibited a Brookfield viscosity of 131 cps using an RV #2 spindle at 100 rpm, 25° C. E7 and E8 demonstrate the synergistic benefit of the combination of dispersing agent and viscosity reducing compound both with and without water facilitating the hydrolysis of siloxane groups in the viscosity reducing compound.

For Example 9 (E9), a 70 wt % solids pigment dispersion was made with a 25:1 weight ratio of pigment to the combined weight of the dispersing agent and the viscosity reducing compound. The ratio of the dispersing agent to the viscosity reducing compound was 3:1. In a similar manner to CE4, 27.1 g of RK-36778 dispersant and 3.70 g of N-(2-aminoethyl)-3-aminopropyltrimethoxysilane (GENIOSIL® GF-91, Wacker Chemical Corp., Adrian, Mich.) were dissolved into 124.3 g of BEA along with 0.90 g of deionized water, followed by the portion-wise addition of the 370 g TiO₂. The resulting pigment dispersion exhibited a Brookfield viscosity of 128 cps using an RV #3 spindle at 100 rpm, 25° C.

### Example 10 and Comparative Example 5

Example 10 demonstrate the synergistic benefit of using both a dispersing agent and a viscosity reducing compound in a pigment dispersion using a titanate viscosity reducing compound.

For Comparative Example 5 (CE5), a 70 wt % solids pigment dispersion was made with a 50:1 weight ratio of pigment to viscosity reducing compound. In a similar manner to CE1, 3.7 g of isopropyl tri(dioctyl)phospato titanante (KR-38S, Kenrich Petrochemicals) were dissolved into 74.3 g of BEA, followed by the portion-wise addition of the 185 g TiO₂. The resulting pigment dispersion was a thick paste which flowed somewhat when shaken but was deemed not measureable on the Brookfield viscometer, indicating that addition of titanate coupling agent alone does not sufficiently decrease the viscosity of the pigment dispersion.

For Example 10 (E10), a 70 wt % solids pigment dispersion was made with a 25:1 weight ratio of pigment to the combined weight of the dispersing agent and the viscosity reducing compound. The ratio of the dispersing agent to the viscosity reducing compound was 7:1. In a similar manner to CE5, 31.6 g of RK-36778 dispersant and 1.85 g of KR-38S were dissolved into 122.6 g of BEA, followed by the portion-wise addition of the 370 g TiO₂. The resulting pigment dispersion exhibited a Brookfield viscosity of 119 cps using an RV #3 spindle at 100 rpm, 25° C. Despite having half as much titanate coupling agent as CE5, the synergistic effect of having both dispersing agent and viscosity reducing compound in E10 greatly reduces the viscosity of the pigment dispersion.

Table 1 summarizes the viscosities of pigment dispersions E1-E10 along with CE1-CE5 at 50 rpm and 100 rpm. Viscosities that were above the measurable range for the instrument configuration are listed as “EEE”. Viscosities that were measured with a torque below the range recommended for accurate measurement (torque less than 10%) are labeled with an asterisk. The ratios listed are solids weight ratios for the pigment to the combined weight of the dispersing agent and the viscosity reducing compound, P:(D+VR), the dispersing agent to the viscosity reducing compound, D:VR, and the pigment to the viscosity reducing compound, P:VR.

TABLE 1

| | | | | Ratios | | | Viscosity (cps) | |
|---|---|---|---|---|---|---|---|---|
| Example | % Solids | Dispersant | Viscosity Reducer | P:(D + VR) | D:VR | P:VR | 50 rpm | 100 rpm |
| CE1 | 70 | EFKA ® 4320 | none | 50 | — | — | 548 | 370 |
| CE2 | 70 | none | Dynasylan ® 1189 | 50 | — | 50 | 7648 | EEE |
| E1 | 70 | EFKA ® 4320 | Dynasylan ® 1189 | 50 | 1 | 100 | — | 113 |
| E2 | 70 | EFKA ® 4320 | Dynasylan ® 1189 | 50 | 3 | 200 | — | 134 |
| CE3 | 78 | EFKA ® 4320 | none | 25 | — | — | EEE | EEE |
| E3 | 78 | EFKA ® 4320 | Dynasylan ® 1189 | 25 | 3 | 100 | 2816 | 2196 |
| E4 | 78 | EFKA ® 4320 | Dynasylan ® 1189 | 25 | 3 | 100 | 1792 | 1440 |
| CE4 | 70 | RK36778 | none | 25 | — | — | 276 | 188 |
| E5 | 70 | RK36778 | Dynasylan ® 1189 | 50 | 1 | 100 | 150 | 176 |
| E6 | 70 | RK36778 | Dynasylan ® 1189 | 33 | 2 | 100 | 100 | 135 |
| E7 | 70 | RK36778 | Dynasylan ® GLYMO | 33 | 2 | 100 | 103 | 126 |
| E8 | 70 | RK36778 | Dynasylan ® GLYMO | 33 | 2 | 100 | 109 | 131 |
| E9 | 70 | RK36778 | GENIOSIL ® GF-91 | 25 | 3 | 100 | 148* | 128 |
| CE5 | 70 | none | KR-38S | 50 | — | 50 | EEE | EEE |
| E10 | 70 | RK36778 | KR-38S | 25 | 7 | 200 | 124* | 119 |

### Examples 11-16 and Comparative Examples 6-11

Examples 11-16 demonstrate the effect of adding viscosity reducing compounds to fluoropolymer resin dispersions containing pigment dispersion and dispersing agent.

For Example 11 (E11), a 500 ml beaker was charged with 200 g of a 45 wt % solids dispersion of milled PVF in propylene carbonate (PC). Varying amounts of Dynasylan® 1189 were added to the dispersion, followed by the addition of 32 g of TiO₂ pigment dispersion (70 wt % TiO₂ Ti-Pure® R-960 dispersed with 8.9 wt % RK-36778 in BEA). This dispersion was stirred for 5 minutes. After sitting for 15 minutes the viscosity of each sample was measured using an RV #5 spindle at 100 rpm, 25° C. The viscosities listed in Table 2 include samples with zero (VRO), 0.066 wt % (VR1), 0.25 wt % (VR2) and 0.51 wt % (VR3) of the viscosity reducing compound. These weight percents represent the weight of Dynasylan® 1189 added relative to the overall weight of the dispersion. The effect of adding the viscosity reducing compound is to reduce the viscosity of the dispersion.

TABLE 2

| | | Viscosity | | | |
|---|---|---|---|---|---|
| | | (cps @ 100 rpm) | | | |
| Example | Compound | VR0 | VR1 | VR2 | VR3 |
| E11 | Dynasylan ® 1189 | 1,564 | 884 | 568 | 668 |
| E12 | DBU | 1,572 | 884 | 1,208 | 1,228 |
| E13 | DBA | 1,568 | 1,112 | 1,056 | 1,012 |
| E14 | Z-6106 Silane | 1,632 | 1,660 | 1,432 | 1,348 |
| E15 | Dynasylan ® OCTEO | 1,648 | 1,576 | 1,440 | 1,332 |
| E16 | Dynasylan ® DAMO-T | 1,632 | 728 | 532 | 604 |

For Example 12 (E12), a dispersion was made as in E11, but with a different viscosity reducing compound, diazabicyclo[5.4.0]undec-7-ene (DBU, Sigma-Aldrich, St. Louis, Mo.). In this example, the viscosities listed in Table 2 include samples with zero (VRO), 0.057 wt % (VR1), 0.26 wt % (VR2) and 0.50 wt % (VR3) of the viscosity reducing compound. Once again, the effect of adding the viscosity reducing compound is to reduce the viscosity of the dispersion.

For Example 13 (E13), a dispersion was made as in E11, but with a different viscosity reducing compound, dibutylamine (DBA, Sigma-Aldrich).

In this example, the viscosities listed in Table 2 include samples with zero (VRO), 0.049 wt % (VR1), 0.25 wt % (VR2) and 0.50 wt % (VR3) of the viscosity reducing compound. Once again, the effect of adding the viscosity reducing compound is to reduce the viscosity of the dispersion.

For Example 14 (E14), a dispersion was made as in E11, but with a different viscosity reducing compound, 3-glycidoxypropyltrimethoxysilane (Z-6106 Silane, Dow Corning Corp., Midland, Mich.). In this example, the viscosities listed in Table 2 include samples with zero (VRO), 0.050 wt % (VR1), 0.26 wt % (VR2) and 0.53 wt % (VR3) of the viscosity reducing compound. In this case, the effect of adding the viscosity reducing compound is to maintain or slightly reduce the viscosity of the dispersion.

For Example 15 (E15), a dispersion was made as in E11, but with a different viscosity reducing compound, octyltriethoxysilane (Dynasylan® OCTEO, Evonik). In this example, the viscosities listed in Table 2 include samples with zero (VRO), 0.050 wt % (VR1), 0.26 wt % (VR2) and 0.53 wt % (VR3) of the viscosity reducing compound. In this case, the effect of adding the viscosity reducing compound is to slightly reduce the viscosity of the dispersion.

For Example 16 (E16), a dispersion was made as in E11, but with a different viscosity reducing compound, N-(2-aminoethyl)-3-aminopropyltrimethoxysilane (Dynasylan® DAMO-T, Evonik). In this example, the viscosities listed in Table 2 include samples with zero (VRO), 0.051 wt % (VR1), 0.25 wt % (VR2) and 0.61 wt % (VR3) of the viscosity reducing compound. As in the case of E11, the effect of adding the viscosity reducing compound is to dramatically reduce the viscosity of the dispersion.

These examples demonstrate that the use of a viscosity reducing compound and a dispersing agent in a dispersion containing fluoropolymer resin and pigment can prevent the sometimes dramatic increase in viscosity that can occur when a pigment dispersion is added to a fluoropolymer resin dispersion. In some cases, the viscosity of the overall dispersion is maintained in a process-friendly range, and in other cases, the viscosity is reduced, sometime dramatically, enabling liquid fluoropolymer coating compositions with higher formulated solids content and/or lower final formulation viscosities.

### Examples 17-23 and Comparative Example 6

Examples 17-23 demonstrate the effect of adding a viscosity reducing compound and a mixed catalyst to a liquid fluoropolymer coating composition containing pigment dispersion.

For Comparative Example 6 (CE6), a liquid fluoropolymer coating composition was made from 120 g of a 42 wt % solids dispersion of PVF in propylene carbonate. To this was added, with stirring, 19 g of BEA, 5 g of a 50 wt % solution of Desmophen® C-3100 (Bayer Materials Science, Pittsburgh, Pa.) in BEA, 2.9 g of Desmodur® PL-350 (Bayer Materials Science), and a mixed catalyst system. The mixed catalyst was added as 1.5 g of a main catalyst solution (0.1 g dibutyl tin dilaurate (DBTDL) and 1 g acetic acid in 24 g of BEA), and 1.5 g of a co-catalyst solution (1 g of bismuth 2-ethylhexanoic acid (K-KAT 348, King Industries) in 24 g of BEA). The resulting coating composition had 0.015 pph DBTDL and 0.15 pph K-KAT 348 based on parts per hundred (pph) fluoropolymer resin solids. To this mix, was added 32 g of TiO₂ pigment dispersion (70 wt % TiO₂ Ti-Pure® R-960 dispersed with 8.9 wt % RK-36778 in BEA). The viscosity of this dispersion was 14,000 cps using an RV #5 spindle at 10 rpm, 25° C.

The coating composition was stirred for 2 minutes, and then coated as a 5 mil thick wet drawdown on polyester (10 mil corona treated BH116, Nan Ya Plastics Corp., Taiwan) and cured at 220° C. for 120 seconds. The dried film could not be peeled off of the polyester.

For Example 17 (E17), a liquid fluoropolymer coating composition was made as in CE6 with the addition of 0.025 wt % (based on the total weight of the liquid fluoropolymer coating composition) of Dynasylan® 1189. The viscosity of this dispersion was 7400 cps using an RV #5 spindle at 10 rpm, 25° C. The sample was coated onto polyester and cured, as in CE6, resulting in a dried film that could not be peeled off of the polyester.

For Example 18 (E18), a liquid fluoropolymer coating composition was made as in CE6 with the addition of 0.05 wt % of Dynasylan® 1189. The viscosity of this dispersion was 5500 cps using an RV #5 spindle at 10 rpm, 25° C. The sample was coated onto polyester and cured, as in CE6, resulting in a dried film that could not be peeled off of the polyester.

For Example 19 (E19), a liquid fluoropolymer coating composition was made as in CE6 with the addition of 0.07 wt % of Dynasylan® 1189. The viscosity of this dispersion was 3700 cps using an RV #5 spindle at 10 rpm, 25° C. The sample was coated onto polyester and cured, as in CE6, but was readily peeled off of the polyester, indicating that too much viscosity reducing compound in the coating composition can interfere with the adhesion of the dried film.

For Example 20 (E20), a liquid fluoropolymer coating composition was made as in CE6 with the addition of 0.05 wt % of DBA. The viscosity of this dispersion was 9440 cps using an RV #5 spindle at 10 rpm, 25° C. The sample was coated onto polyester, as in CE6, and cured for 2 minutes at 218° C., resulting in a dried film that could not be peeled off of the polyester. The dried film was then placed in an autoclave at 105° C. and 5 psig for 192 hours and still could not be peeled off of the polyester.

For Example 21 (E21), a liquid fluoropolymer coating composition was made as in CE6 with the addition of 0.1 wt % of DBA. The viscosity of this dispersion was 7500 cps using an RV #5 spindle at 10 rpm, 25° C. The sample was coated onto polyester, as in CE6, and cured for 2 minutes at 218° C., resulting in a dried film that could not be peeled off of the polyester. The dried film was then placed in an autoclave at 105° C. and 5 psig for 192 hours and still could not be peeled off of the polyester.

For Example 22 (E22), a liquid fluoropolymer coating composition was made as in CE6 with the addition of 0.05 wt % of DBU. The viscosity of this dispersion was 7100 cps using an RV #5 spindle at 10 rpm, 25° C. The sample was coated onto polyester, as in CE6, and cured for 2 minutes at 218° C., resulting in a dried film that could not be peeled off of the polyester. After 192 hours in an autoclave at 105° C. and 5 psig, the dried film had a peel strength of 3.6 N/cm.

For Example 23 (E23), a liquid fluoropolymer coating composition was made as in CE6 with the addition of 0.1 wt % of DBU. The viscosity of this dispersion was 5500 cps using an RV #5 spindle at 10 rpm, 25° C. The sample was coated onto polyester, as in CE6, and cured for 2 minutes at 218° C., resulting in a dried film that could not be peeled off of the polyester. After 192 hours in an autoclave at 105° C. and 5 psig, the dried film had a peel strength of 3.5 N/cm.

Table 3 summarizes the viscosity results for E17 to E23. The amounts of DBTDL and K-KAT 348 are shown based on parts per hundred (pph) fluoropolymer resin solids. The wt % added of the viscosity reducing compound is based on the total weight of the liquid fluoropolymer coating composition. These examples demonstrate that addition of low levels of a viscosity reducing compound significantly reduces the viscosity of a liquid fluoropolymer coating composition containing a mixed catalyst system and a pigment dispersion (that includes a dispersing agent) without adversely affecting the adhesion of the dried film.

TABLE 3

| | | K-KAT | Catalyst | | Wt % | Viscosity |
|---|---|---|---|---|---|---|
| Example | DBTDL | 348 | Ratio | VR | added | (cps @ 10 rpm) |
| CE6 | 0.015 | 0.15 | 0.1:1 | none | — | 14,000 |
| E17 | 0.015 | 0.15 | 0.1:1 | Dynasylan ® 1189 | 0.025 | 7,400 |
| E18 | 0.015 | 0.15 | 0.1:1 | Dynasylan ® 1189 | 0.05 | 5,500 |
| E19 | 0.015 | 0.15 | 0.1:1 | Dynasylan ® 1189 | 0.07 | 3,700 |
| E20 | 0.015 | 0.15 | 0.1:1 | DBA | 0.05 | 9,440 |
| E21 | 0.015 | 0.15 | 0.1:1 | DBA | 0.10 | 7,500 |
| E22 | 0.015 | 0.15 | 0.1:1 | DBU | 0.05 | 7,100 |
| E23 | 0.015 | 0.15 | 0.1:1 | DBU | 0.1 | 5,500 |

### Examples 24-33 and Comparative Examples 7-16

Examples 24-33 demonstrate the effect of adding a viscosity reducing compound and a mixed catalyst to a liquid fluoropolymer coating composition containing pigment dispersion over a broad range of main catalyst to co-catalyst ratios.

For Comparative Examples 7-16 (CE7-CE16), coating compositions were made as in CE6, but with varying amounts of DBTDL and K-KAT 348 as shown in Table 4 based on parts per hundred (pph) fluoropolymer resin solids. The catalyst ratio is that of the main catalyst to the co-catalyst in parts per hundred based on catalyst solids (i.e., pph DBTDL to pph K-KAT 348) for the mixed catalyst system. Coatings on polyester were cured at 220° C. for times ranging from 60 to 120 seconds as shown in the table. Good initial adhesion can be achieved for all catalyst ratios by curing at 120 seconds. By adjusting the catalyst ratio and/or the catalyst level in the coating composition, good initial adhesion can also be achieved for shorter cure times.

For Examples 24-33 (E24-E33), coating compositions were made as in CE7-CE16, but with the addition of 0.025 wt % based on the total weight of the liquid fluoropolymer coating composition) of Dynasylan® 1189. Once again, good initial adhesion can be achieved for all catalyst ratios by curing at 120 seconds, and by adjusting the catalyst ratio and/or the catalyst level in the coating composition, good initial adhesion can also be achieved for shorter cure times.

The data in Table 4 shows the large effect of a viscosity reducing compound on the viscosity of a liquid fluoropolymer coating composition with a mixed catalyst system without negatively effecting adhesion of the dried film made from the coating, and, in some cases, even improving adhesion.

TABLE 4

| | | K-KAT | Catalyst | | Viscosity | Initial Adhesion | | | |
|---|---|---|---|---|---|---|---|---|---|
| Example | DBTDL | 348 | Ratio | VR | (cps @ 10 rpm) | 60 | 75 | 90 | 120 |
| CE7 | 0.005 | 1 | 0.005:1 | none | 24,520 | none | good | good | good |
| E24 | 0.005 | 1 | 0.005:1 | Dynasylan ® 1189 | 8,860 | none | good | good | good |
| CE8 | 0.005 | 0.5 | 0.01:1 | none | 36,720 | none | none | good | good |
| E25 | 0.005 | 0.5 | 0.01:1 | Dynasylan ® 1189 | 9,640 | none | none | none | good |
| CE9 | 0.005 | 0.25 | 0.02:1 | none | 28,480 | none | none | none | good |
| E26 | 0.005 | 0.25 | 0.02:1 | Dynasylan ® 1189 | 10,600 | none | none | none | good |
| CE10 | 0.015 | 0.15 | 0.1:1 | none | 20,360 | good | good | good | good |
| E27 | 0.015 | 0.15 | 0.1:1 | Dynasylan ® 1189 | 8,860 | good | good | good | good |
| CE11 | 0.005 | 0.005 | 1:1 | none | 11,320 | none | none | none | good |
| E28 | 0.005 | 0.005 | 1:1 | Dynasylan ® 1189 | 7,440 | none | none | none | good |
| CE12 | 0.1 | 0.1 | 1:1 | none | 11,200 | good | good | good | good |
| E29 | 0.1 | 0.1 | 1:1 | Dynasylan ® 1189 | 5,880 | good | good | good | good |
| CE13 | 0.1 | 0.05 | 2:1 | none | 9,240 | good | good | good | good |
| E30 | 0.1 | 0.05 | 2:1 | Dynasylan ® 1189 | 4,800 | good | good | good | good |
| CE14 | 0.1 | 0.025 | 4:1 | none | 9,120 | none | none | good | good |
| E31 | 0.1 | 0.025 | 4:1 | Dynasylan ® 1189 | 5,120 | good | good | good | good |
| CE15 | 0.1 | 0.005 | 20:1 | none | 9,080 | none | none | none | good |
| E32 | 0.1 | 0.005 | 20:1 | Dynasylan ® 1189 | 4,840 | none | good | good | good |
| CE16 | 0.1 | 0.0005 | 200:1 | none | 8,960 | none | good | good | good |
| E33 | 0.1 | 0.0005 | 200:1 | Dynasylan ® 1189 | 5,280 | none | none | none | good |

Note that not all of the activities described above in the general description or the examples are required, that a portion of a specific activity may not be required, and one or more further activities may be performed in addition to those described. Still further, the order in which activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that one or more modifications or one or more other changes can be made without departing from the scope of the invention as set forth in the claims below. Accordingly, the specification and figures are to be regarded in an illustrative rather than a restrictive sense and any and all such modifications and other changes are intended to be included within the scope of invention.

Any one or more benefits, one or more other advantages, one or more solutions to one or more problems, or any combination thereof has been described above with regard to one or more specific embodiments. However, the benefit(s), advantage(s), solution(s) to problem(s), or any element(s) that may cause any benefit, advantage, or solution to occur or become more pronounced is not to be construed as a critical, required, or essential feature or element of any or all of the claims.

It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any sub-combination. Further, reference to values stated in ranges include each and every value within that range.

What is claimed is:

1. A pigment dispersion comprising:
a pigment;
a dispersing agent comprising a block acrylic compound or a graft acrylic compound;
a viscosity reducing compound; and
solvent.

2. The pigment dispersion of claim 1, wherein the pigment comprises a metal oxide compound.

3. The pigment dispersion of claim 2, wherein the metal oxide compound comprises titanium dioxide.

4. The pigment dispersion of claim 1, wherein the viscosity reducing compound comprises a coupling agent, an amine or a mixture thereof.

5. The pigment dispersion of claim 4, wherein the coupling agent comprises a silane, a titanate or a zirconate.

6. The pigment dispersion of claim 4, wherein the viscosity reducing compound comprises an amino silane or an epoxy silane.

7. The pigment dispersion of claim 6, wherein the viscosity reducing compound is selected from the group consisting of 3-aminopropyltrimethoxysilane, 3-aminopropyltriethoxysilane, N-(n-butyl)-3-aminopropyltrimethoxysilane, N-(2-aminoethyl)-3-aminopropyltrimethoxysilane, N-2-(vinylbenzylamino)-ethyl-aminopropyltrimethoxysilane), 3-glycidoxypropyltrimethoxysilane, β-(3,4-epoxycyclohexyl)ethyltrimethoxysilane and mixtures thereof.

8. The pigment dispersion of claim 5, wherein the titanate is selected from the group consisting of isopropyl tri(dioctyl)phosphato titanate, isopropyl tri(N-ethylenediamino)ethyl titanate, neopentyl(diallyl)oxy-tri(m-amino)phenyl titanate, neopentyl(diallyl)oxy-tri(N-ethylenediamino)ethyl titanate, and mixtures thereof.

9. The pigment dispersion of claim 5, wherein the zirconate is selected from the group consisting of neopentyl(diallyl)oxy-tri(diactyl)pyro-phosphato zirconate, neopentyl(diallyl)oxy-tri(N-ethylenediamino)ethyl zirconate, neopentyl(diallyl)oxy-tri(m-amino)phenyl zirconate and mixtures thereof.

10. The pigment dispersion of claim 4, wherein the amine comprises a primary amine, a secondary amine or a tertiary amine.

11. The pigment dispersion of claim 10, wherein the amine comprises a dialkyl or trialkyl amine of the general structure N—R¹R²R³, where R¹ and R² are a C1-C20 linear, branched or cycloaliphatic hydrocarbon, and R³ is hydrogen or a C1-C20 linear, branched or cycloaliphatic hydrocarbon.

12. The pigment dispersion of claim 10, wherein the amine is selected from the group consisting of dibutylamine, 4-diazabicyclo[2.2.2]octane, diazabicyclo[5.4.0]undec-7-ene, morpholine, quinuclidine, pyrrolidine, piperazine, and mixtures thereof.

13. The pigment dispersion of claim 1, wherein the pigment solids content is in a range of from about 50 to about 85 weight percent.

14. The pigment dispersion of claim 13, wherein the pigment solids content is in a range of from about 60 to about 80 weight percent.

15. The pigment dispersion of claim 14, wherein the pigment solids content is in a range of from about 70 to about 75 weight percent.

16. The pigment dispersion of claim 1, wherein the solids weight ratio of the pigment to the viscosity reducing compound is in the range of from about 10:1 to about 2000:1.

17. The pigment dispersion of claim 16, wherein the solids weight ratio of the pigment to the viscosity reducing compound is in the range of from about 20:1 to about 1000:1.

18. The pigment dispersion of claim 17, wherein the solids weight ratio of the pigment to the viscosity reducing compound is in the range of from about 40:1 to about 500:1.
